(19) United States
(12) Patent Application Publication
(10) Pub. No.: US 2017/0194026 A1
(43) Pub. Date: Jul. 6, 2017

(54) PERPENDICULAR MAGNETIC RECORDING MEDIUM AND MANUFACTURING METHOD OF THE SAME

(71) Applicant: Kabushiki Kaisha Toshiba, Tokyo (JP)

(72) Inventors: Kaori Kimura, Yokohama Kanagawa (JP); Soichi Oikawa, Hachioji Tokyo (JP); Takeshi Iwasaki, Inagi Tokyo (JP)

(73) Assignees: Kabushiki Kaisha Toshiba, Minato-ku, Tokyo (JP); Kabushiki Kaisha Toshiba, Minato-ku, Tokyo (JP)

(21) Appl. No.: 15/060,871

(22) Filed: Mar. 4, 2016

(30) Foreign Application Priority Data
Jan. 4, 2016 (JP) 2016-000168

(51) Int. Cl. G11B 5/84; G11B 5/667

(52) U.S. Cl. CPC G11B 5/84; G11B 5/667

(57) ABSTRACT

According to one embodiment, a perpendicular magnetic recording medium includes a substrate, an underlayer including projections arranged at an average interval of 3 to 20 nm, an amorphous magnetic recording layer having a plurality of columnar magnetic grains on the surface of the projections, each having a magnetization easy axis in a direction perpendicular to a surface of the underlayer. The underlayer is formed such that 0.5d≦r≦1.5d, where r is the radius of curvature of a vertical section of each projection and d is the average interval between the projections.

### CROSS-REFERENCE TO RELATED APPLICATIONS

This application is based upon and claims the benefit of priority from Japanese Patent Application No. 2016-000168, filed Jan. 4, 2016, the entire contents of which are incorporated herein by reference.

### FIELD

Embodiments described herein relate generally to a perpendicular magnetic recording medium and a manufacturing method of the same.

### BACKGROUND

Magnetic recording media of nowadays often use a perpendicular magnetic recording scheme, and in this scheme, perpendicular orientation of a recording layer and isolation of particles of a magnetic substance must be secured concurrently. Conventionally, adopted is a granular structure in which particles of a ferromagnetic substance (such as CoPt alloy, FePt alloy, and CoPd alloy) are oriented perpendicularly in a matrix of an oxide (such as SiOₓ, TiOₓ, and AlOₓ). However, as the number of particles per bit is reduced for increasing density of the medium, the size of particles of the magnetic substance becomes irregular. The irregularity of the particle size is mainly caused by asperity (prolectionity and concavity) of the underlayer, crystal grain size, and the like. Although many attempts have been made, the irregularity is still the problem. One reason is that both the granular structure and the crystalline anisotropy can be satisfied only by specific materials such as Ru and MgO, and another reason is that the recording layer itself is crystalline and grains therein grow uniquely. In contrast, if an amorphous magnetic recording layer is used, perpendicular orientation can be achieved without depending on an underlayer and the shape of the underlayer can be traced easily because there is no unique grain growth. That is, if an amorphous material is used for the magnetic recording layer, a structure with less irregularity of particle size will be created without consideration of the material of the underlayer.

In recent years, bottom-up media have been proposed. To create such bottom-up media, an amorphous magnetic recording layer formed of a transitional metal-rare earth alloy is grown in the form of columns on an underlayer with regularly patterned asperity. Some amorphous magnetic recording layers have a fan-like structure that spreads from the underlayer toward the surface of the medium in a vertical section. In the fan-like structure, although separation of magnetic grains is excellent, empty space is created in the underlayer side, and the magnetic volume will be lost for that space. On the other hand, if the pattern pitch in the fan-like structure is narrowed, magnetic grains may be connected together to adversely create a continuous film.

### BRIEF DESCRIPTION OF THE DRAWINGS

FIG. 1 is a schematic vertical section which shows an example of the magnetic recording medium of an embodiment.

FIG. 2 is a schematic top view of an arrangement pattern of projections.

FIG. 3 is a schematic top view of an arrangement pattern of projections.

FIG. 4 is a schematic top view of an arrangement pattern of projections.

FIG. 5 shows an example of a vertical section of an inappropriately formed magnetic recording layer.

FIG. 6 shows an example of a vertical section of an appropriately formed magnetic recording layer.

FIG. 7 shows an example of a vertical section of an inappropriately formed magnetic recording layer.

FIG. 8 shows a method of acquiring a radius of curvature.

FIG. 9 shows a method of acquiring a radius of curvature.

FIG. 10 shows a method of acquiring a radius of curvature.

FIG. 11 shows an example of the structure of an underlayer of the embodiment.

FIG. 12 shows another example of the structure of the underlayer of the embodiment.

FIG. 13 shows another example of the structure of the underlayer of the embodiment.

FIG. 14 shows another example of the structure of the underlayer of the embodiment.

FIGS. 15A, 15B, 15C, 15D, and 15E are schematic views which show an example of a manufacturing process of a magnetic recording medium of embodiments.

FIGS. 16A, 16B, 16C, 16D, 16E, and 16F are schematic views which show another example of the manufacturing process of the magnetic recording medium of the embodiment.

### DETAILED DESCRIPTION

According to a first embodiment, a perpendicular magnetic recording medium includes a substrate, underlayer formed on the substrate, and amorphous magnetic recording layer formed to contact the underlayer.

The underlayer includes a plurality of projections.

The projections are arranged at intervals of 3 to 20 nm.

Intervals between the projections are measured as distances between centers of gravity of adjacent projections.

The underlayer is a monolayer or a multilayer including two or more layers therein. The surface layer of the underlayer can contact the amorphous magnetic recording layer.

The underlayer is formed such that

0.5d≦r≦1.5d (1)

where r is the radius of curvature of each projection and d is the average interval between the projections.

The amorphous magnetic recording layer is formed on the surfaces of the projections to have a columnar structure.

In the columnar structure, each magnetic grain which is separated from other magnetic grains grown in the form of a column on a projection of the underlayer such that sidewalls of the magnetic grain extends vertically with respect to the substrate, and the tip of each column is separated from tips of the other columns. The tip of the columnar structure is not necessarily parallel to the substrate and may be made flat or curved. Furthermore, each column may be formed as a cylindrical column, hexagonal column, pentagonal column, or the like.

Furthermore, the amorphous magnetic recording layer includes a plurality of magnetic grains having a magnetization easy axis in a direction perpendicular to the underlayer surface.

In the perpendicular magnetic recording medium of this embodiment, the shape of each projection of the underlayer, that is, its curvature is specified. Consequently, the magnetic recording layer having a columnar structure with a narrowed pitch can be achieved. The magnetic recording layer having a columnar structure can produce a magnetic volume which is greater than a magnetic recording layer having a fan-like structure. Therefore, the magnetic recording layer of this embodiment achieves greater signal strength and improved magnetic recording characteristics.

According to a second embodiment, a manufacturing method of a magnetic recording medium is presented. The method is an example of manufacturing methods of the perpendicular magnetic recording medium of the first embodiment.

The method includes: forming a first underlayer on a substrate;

forming nanoparticle monolayer by applying a nanoparticle dispersion fluid on the first underlayer;

performing etching of the first underlayer via the nanopartcles to form the underlayer including projections are represented by the following formula (1)

0.5d≦r≦1.5d (1),

where r is the radius of curvature of each projection and d is the average interval between the projections; and

depositing an amorphous magnetic recording layer on surfaces of the projections.

According to a third embodiment, a manufacturing method of a magnetic recording medium is presented. The method is another example of the manufacturing methods of the perpendicular magnetic recording medium of the first embodiment.

The method includes: forming a first underlayer using a metal compound having a eutectic structure including particles and grain boundaries;

performing etching to maintain the particles of the eutectic structure in a state such that the first underlayer includes projections are represented by the following formula (1)

0.5d≦r≦1.5d (1),

where r is the radius of curvature of each projection and d is the average interval between the projections; and

depositing an amorphous magnetic recording layer on surfaces of the projections.

In addition, according to another embodiment, a manufacturing method of a magnetic recording medium is presented. In this method, before depositing an amorphous magnetic recording layer on surfaces of projections as in the manufacturing method of the second or third embodiment, a second underlayer is formed. The method further includes a step of forming an underlayer including the second underlayer as a surface layer of the first underlayer in addition to the steps of the second or third embodiment, and the underlayer satisfies the formula (1).

Hereinafter, embodiments will be explained with reference to the accompanying drawings.

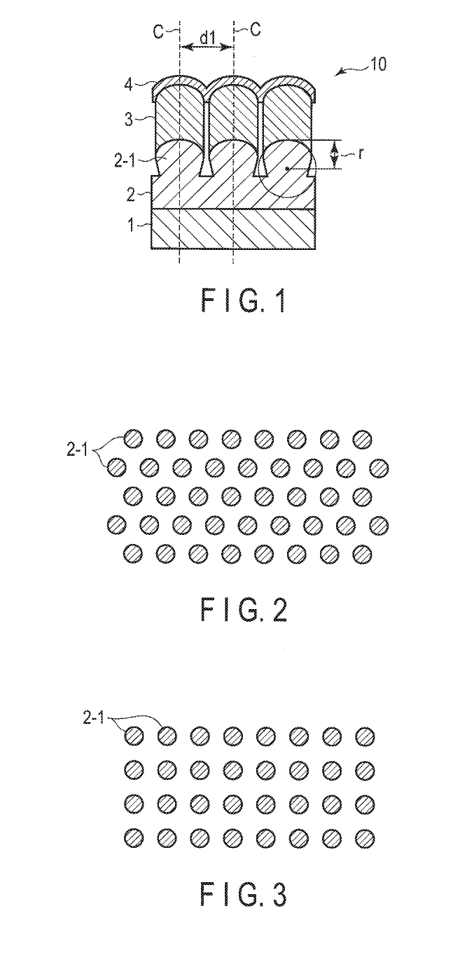

FIG. 1 is a schematic vertical section of an example of a magnetic recording medium of an embodiment.

As depicted, a magnetic recording medium 10 includes a substrate 1, an uneven underlayer 2 including plurality of projections on a surface and formed on the substrate 1, amorphous magnetic recording layer 3 formed of a transition metal-rare earth alloy on the uneven underlayer 2, and protective layer 4 formed on the amorphous magnetic recording layer 3.

In the magnetic recording medium 10, the underlayer is a monolayer of the uneven underlayer 2. However, the underlayer may be a multilayer including the uneven underlayer 2 and an anti-oxidation layer or an intermediate layer for better shape. In that case, the underlayer opposed to the substrate 1 contacts the amorphous magnetic recording layer 3.

The amorphous magnetic recording layer 3 has a columnar structure.

In the above formula (1), d is an average value of d1s which are intervals between the centers of gravity cs of adjacent projections 2-1 in a regularly arranged area. Furthermore, r is the radius of curvature of the outermost surface of the nonmagnetic layer which is immediately below the recording layer 3.

FIGS. 2 to 4 are schematic views of an arrangement pattern of projections of the uneven underlayer 2, as being viewed from the top.

Projections 2-1 of the underlayer 2 can be arranged in a regular pattern. Such a regular pattern will be a hexagonal lattice closest packed pattern with a pitch of, for example, 3 to 20 nm between projections 2-1 as being viewed from the top as in FIG. 2. Or, such a regular pattern will be a tetragonal lattice pattern with the same pitch as in FIG. 3. Projections are not necessarily formed in circles and may be formed in polygons such as hexagon or quadrangle.

If the pitch is greater than 20 nm, the recording density of the magnetic recording medium tends to decrease. Furthermore, if the pitch is less than 3 nm, data recorded in the medium tend to vanish by the thermal fluctuation effect.

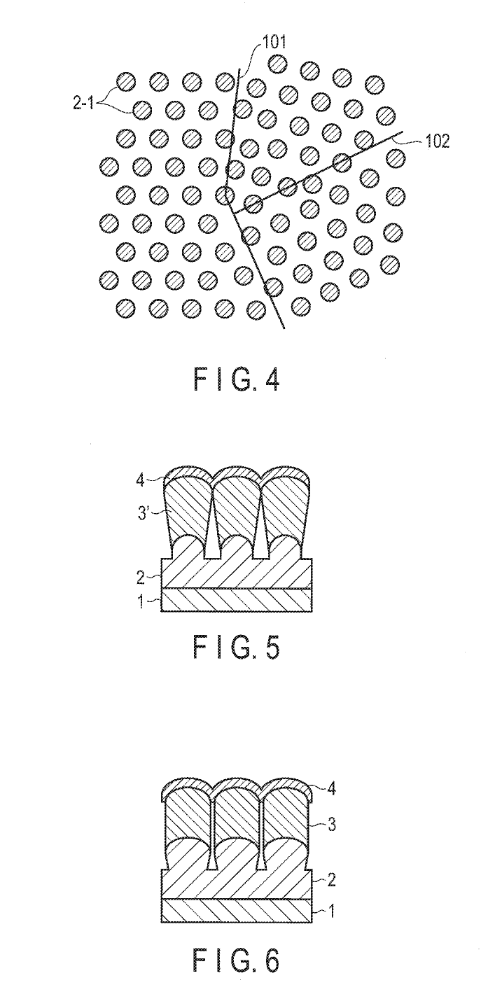

Such a pattern may include a collection of domains of a few hundred nanometers or more defined by border lines 101 and 102 as in FIG. 4, that is, a collection of regularly-arranged patterns. The arrangement is not necessarily a perfect closest-packed arrangement.

Therein, the amorphous magnetic recording layer grows depending on a relationship between factors d and r.

FIGS. 5 to 7 are vertical sections of magnetic recording layers growing depending on a relationship between an average interval d and a radius of curvature r between projections.

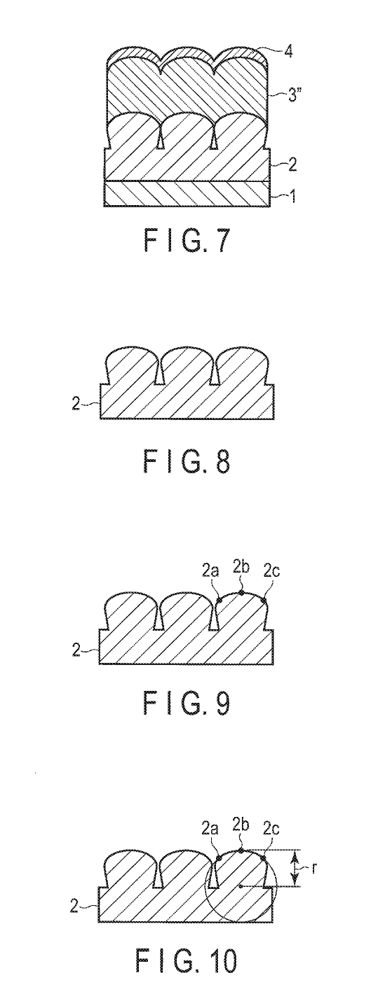

If the above formula (1) is not satisfied because r is less than 0.5d, a space is created from the center of a projection to the proximity of its sidewall as in FIG. 5, and sputtered particles may be stacked in the space. As a result, a magnetic recording layer 3′ is deposited by sputtered particles adhered to the sidewalls, and the recording layer 3′ grows in the form of a fan. If the above formula (1) is satisfied, a projection has a radius of curvature which is greater than that of FIG. 5 as in FIG. 6. Consequently, the magnetic recording layer deposited on the projection has a greater area. Since sputtered particles are not easily stacked in grooves between projections, the magnetic recording layer 3 is only deposited on the top of the projection to grow in the form of a column. If the above formula (1) is not satisfied because r is greater than 1.5d, sputtered particles are adhered to projections and depressions almost indiscriminately, and a magnetic recording layer 3″ is deposited as a continuous film as in FIG. 7. Since a continuous film does not fix a domain wall, this is not a suitable structure for a magnetic recording medium.

To optimize the radius of curvature of the underlayer, a multilayered structure may be adopted in the underlayer to have two or more layers therein. The radius of curvature of the outermost surface of the uneven underlayer can be controlled by changing a material and a film formation method of the underlayer. Specifically, the multilayered underlayer may include an anti-oxidation layer to prevent oxidation from the bottom side.

Projections of the underlayer have a height of 1 to 25 nm.

If the height exceeds 25 nm, the structural density decreases and thus the medium strength decreases. If the height is less than 1 nm, sputtered particles are adhered to projections almost indiscriminately and an amorphous recording layer tends to be a continuous film as in the case where 1.5d<r.

Hereinafter, materials and structures will be explained in detail.

### <First Uneven Underlayer (First Underlayer)>

Various materials can be used for the first uneven underlayer in consideration of corrosivity and resistivity.

As such materials for the first uneven underlayer, there are inorganic materials such as C and Si, metal materials such as Al, Ti, Cr, Mn, Fe, Co, Ni, Cu, Zn, Ge, Zr, Nb, Mo, Ru, Rh, Pd, Ag, In, Hf, Ta, W, Ir, Pt, Au, and alloy of such materials (such as CrTi and NiW), and oxidant or nitride of such materials. Specifically, materials such as C, Al, Ta, Fe, Pt, and Au tend to show excellence in formation of projections and in affinity with amorphous materials.

The first uneven underlayer is patterned to have a regular arrangement including area domains of a few hundred nanometers as in FIG. 4.

An average interval d between projections of the first uneven underlayer is 3 to 20 nm. Even if d is set such that 0.5d≦r≦1.5d is satisfied, an average interval d greater than 20 nm widens a gap between projections, and the recording layer cannot have a columnar structure but have a fan-like structure. Furthermore, an average interval d less than 3 nm narrows a gap between projections, and the recording layer cannot have a columnar structure but have a continuous film structure.

The first uneven underlayer takes the form of, in many cases, a round-edged truncated cone. In a vertical sectional view with respect to the substrate of the projection of the first uneven underlayer, an approximation of the rounded-edge is made by a circle and the radius of the circle is set as the radius of curvature r for the underlayer.

FIGS. 8 to 10 show a method of acquiring the radius of curvature.

To acquire the radius of curvature, a vertical section of a projection of the first uneven underlayer 2 is initially captured by, for example, transmission electron microscopy (TEM) as in FIG. 8. Then, three or more points are put on the rounded-edge of the projection such as points 2a, 2b, and 2c in FIG. 9. Then, a circle overlapping the three points is drawn and the radius r of the circle is acquired as in FIG. 10.

The radius of curvature r is of the underlayer contacting the amorphous magnetic recording layer. Thus, if an additional underlayer is inserted between the first uneven underlayer and the amorphous magnetic recording layer, the above radius acquisition is performed with respect to the additional underlayer.

The radius of curvature r of the first uneven underlayer can be set in the range 1.5 to 30 nm while satisfying 0.5d≦r≦1.5d. As explained above, if r is too small, the amorphous magnetic recording layer grows in the form of a fan, and if r is too large, the amorphous magnetic recording layer grows in a continuous film.

### <Second Uneven Underlayer (Second Underlayer)>

The underlayer may have a multilayered structure including two or more layers therein. For example, a second uneven underlayer can be inserted between the first uneven underlayer and the amorphous recording layer. The second uneven underlayer can be formed of various materials produced by sputtering of a metal or inorganic material. Inorganic material films tend to have greater strength as compared to organic material films.

By the second uneven underlayer, the radius of curvature r can be controlled. IF the second uneven underlayer is formed of an amorphous material such as CrTi, the projections of the underlayer below can be traced and r can be increased. If the second uneven underlayer is a crystalline material such as Ru or Pd, r can be decreased by crystalline growth.

With the second uneven underlayer, additional advantages such as anti-oxidation, anti-corrosion, and good adhesion can be reinforced. The second uneven underlayer may be formed on the projections alone of or both the projections and depressions of the first uneven underlayer.

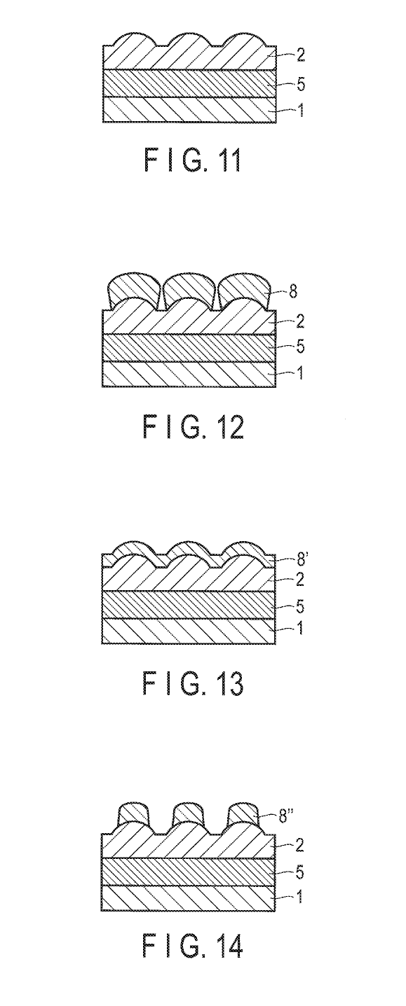

FIGS. 11 to 14 show examples of the structure of the underlayer used in the embodiment.

FIG. 11 shows an example where an underlayer is a monolayer, that is, a second underlayer is not provided therewith. In this example, a first uneven underlayer 2 is disposed on a substrate 1 via a soft magnetic layer 5.

FIG. 12 shows an example where an underlayer has double-layered projections.

The underlayer of FIG. 12 includes a first uneven underlayer 2 disposed on a substrate 1 via a soft magnetic layer 5 and a second uneven underlayer 8 disposed on each of the projections.

FIG. 13 shows an example where an underlayer has a double-layered structure.

The underlayer of FIG. 13 includes a first uneven underlayer 2 disposed on a substrate 1 via a soft magnetic layer 5 and a second uneven underlayer 8′ disposed on the first uneven underlayer 2.

FIG. 14 shows another example where an underlayer has double-layered projections.

The underlayer of FIG. 14 includes a first uneven underlayer 2 having projections on a substrate 1 via a soft magnetic layer 5 and a second uneven underlayer 8″ disposed on each of the projections.

### <Anti-Oxidation Layer>

As a second uneven underlayer interposed between a first uneven underlayer and an amorphous magnetic recording layer, an anti-oxidation layer can be cited for example.

The anti-oxidation layer prevents a dirt material produced during the manufacturing process of the uneven underlayer on the surface thereof from transferring to the amorphous magnetic recording layer which is more reactive to such a dirt material. The dirt material may be oxygen, an oxide, and hydroxide, or rarely, a nitride, chloride, and fluoride. Therefore, the anti-oxidation layer may be formed of a material which as a simple substance does not react to the amorphous magnetic recording layer. The material of the anti-oxidation layer may be a precious metal such as Pd, Ru, Pt, Au, Cu, and Ag, or a transition metal such as Ti, Cr, Fe, Co, Ni, Ta, and W. Furthermore, the material may be amorphous to increase the shape traceability. The materials cited above do not have a large crystal grain in a layer having a thickness of a few nanometers; however, they may have a crystal grain of 5 to 6 nm diameter when the layer thickness is 10 nm or so. Since crystal grains of an anti-oxidation layer do not correspond to the shape of a uneven underlayer, an amorphous magnetic recording layer may possibly grow along the crystal grains of the anti-oxidation layer. If a thickness of an anti-oxidation layer increases, an amorphous material is used for the anti-oxidation layer to avoid the affect caused by such crystal grains. For example, Ni—Ta, Cr—Ti, and Zr—Fe are typical amorphous materials. An amorphous film can be achieved through a sputtering process using a combination of one element selected from a group consisting of Ti, Ta, Hf, Nb, and Zr, and one element selected from a group consisting of Cr, Fe, Co, Ni, Cu, Mo, Rh, Pd, and Ir.

The amorphous material may be nonmagnetic. If being magnetic, the magnetic characteristics of the amorphous material may change by oxidation, and the magnetic characteristics of the amorphous magnetic recording layer which grows on the anti-oxidation layer may change accordingly.

The anti-oxidation layer may be formed to have a thickness of 2 nm or more in consideration of the anti-oxidation. If the thickness of the anti-oxidation layer is less than 2 nm, the deposition of the layer is not continuous and the anti-oxidation effect tends to be insufficient. If the thickness of the anti-oxidation layer is more than 30 nm, the projections shape tends to be too flat. For example, with the anti-oxidation layer having a thickness more than 30 nm, the amorphous magnetic recording layer is formed continuous and has magnetic characteristics of a domain wall transferring type. In consideration of the above factors, the anti-oxidation layer should have a thickness of 2 to 30 nm.

Furthermore, by using the characteristic of the anti-oxidation layer which tends to be flat with increase of its thickness, the radius of curvature r of the anti-oxidation layer can be set desirably. If the anti-oxidation layer is applied with a greater thickness, projections of the underlayer become blunt and the radius of curvature r becomes great. Therefore, a thickness of the anti-oxidation layer is increased to increase the radius of curvature r and is decreased to substantially maintain r.

Furthermore, the anti-oxidation layer may have a multilayered structure. In the multilayered structure, layers therein have different functions such as an anti-oxidation function and an adhesion function. If the layer in the substrate side is crystalline such as Pt and Ta, the layer in the amorphous magnetic recording layer can be made amorphous. If the layer contacting the magnetic recording layer is formed of a material with crystal grains, the boundary shape deterioration may occur as mentioned above. Thus, by disposing an amorphous layer on the layer having crystal grains, uneven of the crystal grains can be reduced and the surface of the crystal grains can be made smooth.

### <Amorphous Magnetic Recording Layer>

Materials usable for the amorphous magnetic recording layer may be, in general, amorphous rate-earth-transition metal (R-TM) alloys. Specifically, Gd—Co, Gd—Fe, Tb—Fe, Gd—Tb—Fe, Tb—Co, Tb—Fe—Co, Nd—Dy—Fe—Co, and Sm—Co alloys are cited for example.

If a rare-earth element used is a light rare-earth element such as Nd, the alloy becomes ferromagnetic because of its magnetization parallel to that of the transition metal. If a rare-earth element is a heavy rare-earth element such as Gd, Tb, and Dy, the alloy becomes ferrimagnetic because of its magnetization opposite to that of the transition metal. With a ferrimagnetic substance, the saturation magnetization Ms decreases and the coercivity Hc can be increased. Furthermore, a transition metal may be Fe, Co, and Ni, for example; however, a Curie temperature Tc becomes below the room temperature in many cases when Ni is used. Thus, Ni is avoided generally.

By adding a small amount of an easily oxidized material such as Cr, Si, Ti, Al, and B to such an alloy, oxidation of the magnetic layer can be suppressed. Or, by adding a small amount of a precious metal such as Au, Pt, and Ag, an oxidation suppression effect can be achieved. Such an additive can be added to the alloy to 30 at %, or preferably, to 10 at % of the entire components. If the additive is above 30 at %, the saturation magnetization Ms tends to decrease and the perpendicular magnetic anisotropy Ku tends to decrease.

Furthermore, the amorphous magnetic recording layer may have a multilayered structure including an amorphous magnetic recording layer, nonmagnetic protective layer formed of Pt, Pd, Au, Cu, Cr, Al or the like, and layer possessing an anti-oxidation effect. One layer of the amorphous magnetic recording layer may have a thickness of 1 nm or more, or preferably, a thickness of 3 to 30 nm. When the amorphous magnetic recording layer has a multilayered structure, the one layer of the amorphous magnetic recording layer is a continuously formed one amorphous magnetic recording layer which is not separated by the nonmagnetic protective layer. If the amorphous magnetic recording layer has a thickness below 1 nm, element diffusion occurs in the adjacent layers, and the perpendicular orientation thereof tends to be weak. Furthermore, if the amorphous magnetic recording layer has a thickness above 30 nm, a columnar structure cannot be shaped and the layer tends to be a continuous film.

If the amorphous magnetic recording layer has a multilayered structure, compositions of the layers therein may be the same or different. For example, TbFeCo having high Ku may be used in a lower layer which is close to the underlayer while TbCoCr having low Ku may be used in an upper layer which is close to the protective layer.

For better separation of the magnetic recording layer, a process gas pressure may be set to 0.5 to 10 Pa during the layer formation. With the pressure below 0.5 Pa, grain separation tends to be insufficient. With the pressure above 10 Pa, in-plane variations in composition and film thickness tend to be exhibited.

Note that the amorphous magnetic recording layer of the present embodiment is disposed on the uneven underlayer and is entirely or partly isolated thereon. Such a state may be referred to as magnetic grains. The term magnetic grains will be used to denote particles of a granular structure. They are different from nanopartcles used in the description.

### <Nonmagnetic Protective Layer>

The nonmagnetic protective layer is disposed between amorphous magnetic recording layers to protect sidewalls. The nonmagnetic protective layer is formed of a material such as Pt, Pd, Au, Cu, Cr, and Al. Such materials are precious metals or passive metals, and thus, they are expected to be a good protective layer for anti-oxidation effect. Furthermore, Pt is easily polarized, and Pd will perform an auxiliary advantage in perpendicular anisotropy including perpendicular magnetic anisotropy by strain.

The material of the nonmagnetic protective layer is introduced between amorphous magnetic recording layers by sputtering, CVD, or ALD for the layer formation. The nonmagnetic protective layer is not necessarily amorphous and may be crystalline. As detailed later, the nonmagnetic protective layer is thin and the affect on the shape of the amorphous magnetic recording layers is negligible.

The nonmagnetic protective layer is formed to have rounded-edge projections as in the amorphous magnetic recording layer. The nonmagnetic protective layer is thickest at the center of the projection and becomes thinner in the proximity of the sidewalls. Unlike an ordinary artificial lattice, the nonmagnetic protective layer requires a certain thickness. For example, an artificial lattice has a thickness of a few angstroms while a nonmagnetic protective layer has a maximum thickness of 0.5 to 3 nm. If the thickness is below 0.5 nm, the anti-oxidation effect tends to be weak, and if the thickness is above 3 nm, exchanging lines to the adjacent layers are cut and the particles of the magnetic recording layer do not make a magnetization reversal as a single magnetic substance. Nonmagnetic grains adhered to the sidewalls may be difficult to directly observe by TEM or the like; however, they will be confirmed by element analysis techniques such as EDX and EELS.

The number of the nonmagnetic protective layers may be set to one to five. If the number is six or more, the ratio of the amorphous magnetic recording layers decreases, and consequently, the perpendicular magnetic anisotropy Ku and the magnetization Ms tend to decrease. Furthermore, a continuous single amorphous magnetic recording layer may have a thickness of 3 nm or more. If the thickness is below 3 nm, the perpendicular magnetic anisotropy Ku tends to be insufficient by the affect of the initial layer. The thickness of the nonmagnetic protective layers may be one third or less of the total thickness of the magnetic recording layer which is a sum of the thickness of the amorphous magnetic recording layers and the thickness of the nonmagnetic protective layers. If the total thickness of the amorphous magnetic recording layers and the nonmagnetic protective layers are considered to be 30 nm or less, the total thickness of the nonmagnetic protective layers should be 10 nm or less. The nonmagnetic protective layers may cause the coercivity Hc of the magnetic recording layer to decrease. In consideration of this point, the composition of the amorphous material used in the magnetic recording layer must be adjusted to have sufficient Hc. Conditions of the formation of the nonmagnetic protective layers may be changed from that of the amorphous magnetic recording layer for the protection of the sidewalls. Specifically, if the formation of the layers is performed by sputtering, the nonmagnetic protective layers are formed in a lower pressure for better coverage of the sidewalls.

### <Magnetic Characteristics of Amorphous Magnetic Recording Layer>

The magnetic recording medium of the present embodiment exerts a magnetization rotational magnetic characteristic. The magnetic characteristic can be measured by a vibration sample magnetometer (VSM) or a Kerr effect measurement device.

The coercivity Hc of the perpendicular magnetic recording layer can be set to 2 kOe or more. If the coercivity Hc is below 2 kOe, high surface recording density becomes difficult to achieve.

The perpendicular magnetic recording layer has a perpendicular squareness ratio of 0.9 or more. The perpendicular squareness ratio is derived by dividing remaining magnetization Mr by saturated magnetization Ms. If the perpendicular squareness ratio is below 0.9, the perpendicular orientation is deteriorated or the thermal stability is partially decreased.

If a magnetic field at a crossing point of a tangent of a magnetization curve in the proximity of Hc and a negative saturated value is given a nucleation field Hn, Hn is less than Hc. Hn should be increased as much as possible in consideration of good read output, thermal fluctuation resistance and data erase resistance during record of adjacent tracks. However, when Hn increases, the gradient α of the magnetization curve in the proximity of Hc increases, and consequently, the signal-to-noise ratio tends to decrease.

In general, the gradient α of the magnetization curve in the proximity of Hc is given by

α=4πdM/dH|H=Hc (2)

where M is the magnetization and H is an external magnetic field. In commercially available perpendicular magnetic recording media of granular type, the gradient α is set to approximately 2 since relatively strong interparticle coupling achieves a good recording and reading characteristic in total. However, high linear recording density and high signal-to-noise ratio are obtainable with weak interparticle coupling. In perpendicular magnetic recording media of granular type, if the gradient α is greater than 3, the interparticle coupling tends to be too strong. Furthermore, if the gradient α is 5 or more, the magnetic grains do not show independent magnetic reversals but tend to show reversals influenced by those of adjacent particles.

### <Manufacturing Method of First Uneven Underlayer>

The first uneven underlayer can be manufactured by treating the first underlayer in various methods.

For example, nanopartcles having a diameter of a few to a few tens of nanometers are arranged uniformly to produce an underlayer with projections. If nanopartcles of less size irregularity are used, size irregularity of the underlayer can be low. A self-assembled material such as diblock copolymer or the like, an alumina nanohole material, and a mesoporous material can achieve the same advantage.

If anodized alumina is used in a template, regularly arranged nanoholes can be obtained by depositing an Al thin film on a substrate, producing electrodes, and then applying a field thereto in an acid solution.

Mesoporous materials will be explained using mesoporous silica as an example. Initially, tetraethoxysilane (TEOS), triblock copolymer, HCl, ethanol, and water are mixed and diluted to a concentration suitable for monolayer arrangement, and the diluted mixture is applied on a substrate as a monolayer by a spincoating method. Then, the block copolymer is removed by baking to produce a regular pattern of holes of a few nanometers on the substrate. The pattern is basically the same as those of nanopartcles and diblock copolymers as in FIG. 2; however, projections are reversed such that the dots denoted by reference number 3 in FIG. 2 are formed as depressions in this example. If a metal material is embedded to the depressions by electroforming or sputtering and an etching process is performed, the projections of the pattern can be reversed to be depressions.

Furthermore, a eutectic structure such as AlSi and AgGe can be adopted. Since the eutectic structure itself does not have projections, an etching process is required to form projections thereon.

One of the above-cited materials is applied to a substrate on which a material for a first underlayer such as carbon is deposited, and an etching process such as RIE is performed to form projections thereon to produce an underlayer. When the pattern is transferred to the substrate, better hardness and adhesion can be achieved as compared to a case where nanopartcles and organic materials are directly used for the underlayer.

The patterning of the first underlayer can be performed through various dry etching processes as circumstances demand. For example, if C is used in the underlayer, an O₂ plasma etching process can be performed. If Si, Ge, Ti, Fe, Co, Cr, Ta, W, and Mo are used, a gaseous halogen etching process with CF₄, CF₄/O₂, CHF₃, SF₆, and Cl₂ can be performed. Furthermore, if a precious metal which is unsuitable for O₂ or halogen etching is used, an ion milling with an inert gas or the like can be performed. If the gaseous halogen etching process is performed, the underlayer must be fully washed with water after the process.

The patterning of the underlayer can be performed through wet etching processes instead. Through a wet etching process, a large number of substrates can be treated at once and the productivity increases. For example, a wet etching process with hydrofluoric acid or an alkaline etching fluid is performed to remove the grain boundary of Si and Ge of the eutectic structure.

### <Nanopartcles>

Nanopartcles used for the underlayer treatment may have a size of 1 to a few tens of nanometers. The shape of nanopartcles is a sphere in many cases, but may be a tetrahedron, rectangular parallelepiped, octahedron, triangle prism, hexagonal prism, or cylinder, for example. In consideration of regular arrangement, a shape of high symmetry is used. The nanopartcles with less size irregularity are used to increase arrangement in the application process. For example, in a manufacturing process of an HDD medium, the size irregularity may be set to 20% or less, or may be reduced to 15% or less. If the size irregularity is reduced, an HDD medium with less jitter noise can be achieved. If the irregularity exceeds 20%, signal-to-noise ratio (SNR) of the medium tends to decrease with increasing jitter noise.

The nanopartcles can be formed of a metal, inorganic substance, or a compound thereof. Specifically, Al, Si, Ti, V, Cr, Mn, Fe, Co, Ni, Zn, Y, Zr, Sn, Mo, Ta, and W are used, for example. Furthermore, an oxide, nitride, boride, carbide, and sulfide of these elements can be used, for example. The nanopartcles may be either crystalline or amorphous. For example, particles of core shell type such as Fe surrounded by FeOₓ (x=1 to 1.5) can be used. The core shell type particles may be composed of different materials such as Fe₃O₄ surrounded by SiO₂. Furthermore, metal core shell type particles such as Co/Fe may be oxidized in their surfaces such that their core shell structure has three or more layers such as Co/Fe/FeOₓ. If the main content is selected from the materials cited above, a compound with a rare metal such as Pt and Ag and the selected can be used. For example, such a compound will be Fe₅₀Pt₅₀.

The arrangement of nanopartcles is performed in a solution system and the nanopartcles are stably dispersed in the solution with protecting groups. In consideration of application to the substrate, the boiling point of a solvent can be set to 200° C. or less, or may be reduced to 160° C. or less. The solvent may be, for example, aromatic hydrocarbon, alcohol, ester, ether, ketone, glycol ether, alicyclic hydrocarbon, and aliphatic hydrocarbon. In consideration of the boiling point and applicability, the solvent may specifically be hexane, toluene, xylene, cyclohexane, cyclohexanone, propylene glycol monomethyl ether acetate (PGMEA), diglyme, ethyl lactate, methyl lactate, and tetrahydfuran (THF). The nanopartcles are dispersed in the solvent and are applied to the substrate as a monolayer through, for example, a spin coating method, dip coating method, or Langhamuir-Blodgett (LB) method.

### <Eutectic>

Through a vapor deposition or a sputtering process of two or more elements, a eutectic structure is prepared. As a eutectic structure, Al—Ge and Ag—Ge are well-known. If an Ag—Ge eutectic structure in which Ag is arranged in a cylindrical manner is used, the desired projections structure can be obtained. At that time, the composition ratio may be set to approximately Ag₂₀Ge₈₀ to Ag₅₀Ge₅₀. If the Ag—Ge structure is soaked into 10% hydrofluoric acid for a few minutes, Ge is dissolved and only Ag can be maintained selectively.

### <Embedding>

A flattening process by embedding may be added to the manufacturing process of the medium of the present embodiment. Embedding is in many cases performed by a sputtering process which targets an embedding material because of its easiness; however, embedding may be performed by other processes such as ion beam vapor deposition, chemical vapor deposition (CVD), and atomic layer deposition (ALD). If CVD or ALD is used, highly-tapered sidewalls of the magnetic recording layer can be embedded with high rate. Furthermore, if the substrate is biased during the embedding, even a high aspect pattern can be embedded without gap. Alternatively, a resist such as spin-on-glass (SOG) and spin-on-carbon (SOC) may be subjected to a spin coating process and hardened by a thermal treatment.

As an embedding material, SiO₂ can be used. However, no limitation is intended thereby, and other embedding materials which satisfy hardness and evenness requirements can be used. For example, amorphous metals such as NiTa and NiNbTi can be used as an embedding material because they are easily evened. Materials mainly containing C such as CNₓ and CHₓ can be used because they harden and improve adhesion to DLC. Furthermore, oxide and nitride of SiO₂, SiNₓ, TiOₓ, and TaOₓ can be used as an embedding material wherein 0<x≦3. Note that, if an embedding layer contacts the magnetic recording layer and produces a reaction product, one protective layer can be interposed between the embedding layer and the magnetic recording layer. The protective layer may be nonoxides of Si, Ti, and Ta, for example.

### <Formation of Protective Layer and Aftertreatment>

To increase coverage with respect to the projection, a carbon protective layer may be formed through a CVD method. Alternately, a sputtering method or a vacuum vapor deposition method may be used. Through a CVD method, a DLC layer containing a large amount of sp³ coupling carbon can be formed. If the thickness is below 2 nm, the coverage will be poor, and if the thickness is 10 nm or more, magnetic spacing between a recording and reading head and a medium increases, and consequently, the SNR tends to decrease. A lubricant can be applied on the protective layer. The lubricant may be, for example, perfluoropolyether, fluoroalcohol, and fluorinated carboxylic acid.

### <Soft Magnetic Undercoating Layer>

A soft magnetic undercoating layer (SUL) functions as a part of the magnetic head, and specifically, the SUL passes a recording magnetic field from a monomagnetic pole horizontally to magnetize a perpendicular magnetic recording layer and returns the recording magnetic field to a magnetic head side. The soft magnetic undercoating layer applies a steep and sufficient perpendicular magnetic field to the recording layer and improves recording and reading efficiency.

The soft magnetic undercoating layer may be formed of a material containing Fe, Ni, or Co. Specifically, such a material may be: FeCo alloy such as FeCo, and FeCoV; FeNi alloy such as FeNi, FeNiMo, FeNiCr, and FeNiSi; FeAl and FeSi alloy such as FeAl, FeAlSi, FeAlSiCr, FeAlSiTiRu, and FeAlO; FeTa alloy such as FeTa, FeTaC, and FeTaN; and FeZr alloy such as FeZrN. Additionally, a material of microcrystalline structure such as FeAlO, FeMgO, FeTaN, and FeZrN containing at least 60 at % of Fe may be used or a material of glanular structure in which micro crystal particles are dispersed within a matrix may be used. Additionally, a Co alloy containing Co and at least one of Zr, Hf, Nb, Ta, Ti, and Y may be used. The Co alloy contains at least 80 at % of Co. The Co alloy tends to form an amorphous layer if it is formed through a sputtering method. Since an amorphous soft magnetic material does not possess crystalline magnetic anisotropy, crystallization defect, or grain boundary, it shows excellent soft magnetization and is effective for noise reduction of the medium. The amorphous soft magnetic material may be, for example, CoZr alloy, CoZrNb alloy, and CoZrTa alloy.

An additional underlayer may be provided below the soft magnetic undercoating layer to improve the crystallization of the soft magnetic undercoating layer or good adhesion to the substrate. Such an additional underlayer may be formed of Ti, Ta, W, Cr, or Pt, or an alloy of these elements, or an oxide or nitride of these elements.

To prevent spike noise, the soft magnetic undercoating layer may be divided into a plurality of layers with Ru of 0.5 to 1.5 nm inserted therebetween such that anti-ferromagnetic coupling is created in the layers. Alternately, a hard magnetic layer of CoCrPt, SmCo, and FePt which possess in-plane anisotropy or a pin layer formed of an antiferromagnetic substance such as IrMn, and PtMn and a soft magnetic layer may be coupled by exchange coupling. To control an exchange coupling force, magnetic layers (such as Co) or nonmagnetic layers (such as Pt) may be provided above and below each Ru layer.

### EXAMPLES

### Example 1

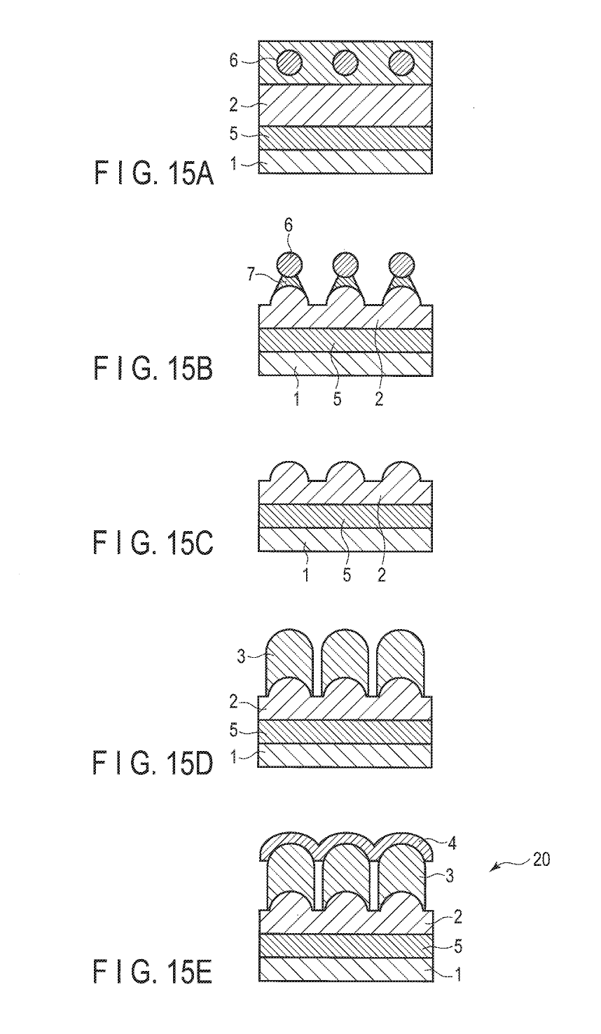

FIGS. 15A to 15E show an example of a manufacturing method of a magnetic recording medium of the present embodiment.

As shown in FIG. 15A, a soft magnetic undercoating layer 5 formed of CoZrNb having a thickness of 50 nm and a first underlayer 2 formed of C having a thickness of 20 nm, which is used for treatment, are formed on a glass substrate 1. Thereupon, FeOₓ nanopartcles 6 having a diameter of 7 nm are applied as a monolayer. Polystyrene of 1000 molecule weight is adhered to the nanopartcles 6 as a protective group and the nanopartcles 6 are arranged on the substrate with an average interval of 10 nm. After the arrangement, the nanopartcles 6 form a hexagonal close-packed pattern as in FIG. 2.

As shown in FIG. 15B, the first underlayer 2 formed of C is subjected to dry etching using the FeOₓ nanopartcles 6 as masks such that the first underlayer 2 and polystyrene around the nanopartcles 6 are etched. Consequently, projections are formed on the substrate 1. This process is performed by, for example, an induction coupling plasma (ICP) RIE apparatus with O₂ used as a process gas, a 0.1 Pa chamber pressure, coil RF power of 50 W and platen RF power of 40 W, and etching time of 40 seconds. Through this process, the C underlayer 2 is etched and the underlayer having projections of a height of 10 nm is formed.

As shown in FIG. 15C, FeOₓ nanopartcles 6 are removed from the first underlayer 2. The substrate 1 is soaked in hydrochloric acid of 1 wt % concentration for 10 minutes such that the FeOₓ nanopartcles 6 are removed from the substrate 1. The substrate 1 is cleansed with pure water to prevent corrosion by a hydrochloric acid residue.

Then, as shown in FIG. 15D, an amorphous magnetic recording layer 3 is deposited on the first underlayer 2. Initially, Tb₃₀Co₇₀ with a thickness of 5 nm and Pt with a thickness of 1.5 nm are deposited. Then, Tb₃₀Co₇₀ with a thickness of 5 nm and Pt with a thickness of 1.5 nm are twice further deposited thereon. Consequently, a multilayered amorphous magnetic recording layer 3 including Tb₃₀Co₇₀ and Pt and having a total thickness of 19.5 nm is obtained.

Furthermore, as shown in FIG. 15E, a DLC protective layer 4 with a thickness of 4 nm is deposited on the magnetic recording layer 3 through chemical vapor deposition (CVD), and a lubricant (not shown) is applied thereto. Consequently, a target magnetic recording medium 20 is obtained.

The medium 20 obtained as above was evaluated by a Kerr effect measurement device. Consequently, the squareness ratio of 1, Hc=3.2 kOe, Hn=1.2 kOe, and Hs=6.1 kOe were confirmed. Furthermore, a loop gradient α in the proximity of the coercivity Hc was 1.0. From the magnetization curve, the medium 20 is estimated not to be a magnetic wall transfer type but to be a reverse mode in which magnetically isolated magnetic grains are rotated magnetically.

The structure of the medium was evaluated by a vertical section TEM. Within the field of view, the amorphous magnetic recording layer showed a columnar structure. The radius of curvature r of tips of the first underlayer immediately below the amorphous magnetic recording layer was measured. An average of r was 5.5 nm which satisfied 0.5d≦r≦1.5d where the average interval d was 10 nm.

### Comparative Example 1

A magnetic recording medium of a comparative example was manufactured in the same manner as example 1 except that a dry etching process of FIG. 15B was performed with an etching time of 15 seconds and projections of the first underlayer formed of C were created to have a height of 2 nm.

The structure of the medium of comparative example 1 was evaluated by vertical section TEM. Within the field of view, the amorphous magnetic recording layer had a substantially continuous structure. The radius of curvature r at a tip of the uneven underlayer immediately below the amorphous magnetic recording layer was 22 nm which showed a relationship 1.5d<r where the average interval d was 10 nm.

Recording and reading characteristics of the medium of example 1 and the medium of comparative example 1 were evaluated. A Guzik read/write analyzer RWA 1632 and a Guzik spinstand S1701MP were used in the evaluation. In evaluating the magnetic recording and reading characteristics, a head with a shielded pole for write and a TMR element for read was used. A recording frequency was measured as 1400 kBPI as the recording density.

Table 1 shows the results.

In the table, separation of particles was graded on the basis of measured traceability of projections of underlayer. If traceability was 90% or more, ⊚ was added. If traceability was 80% or more, ◯ was added. If traceability was 50% or more, Δ was added. If traceability was below 50%, X was added.

TABLE 1

| | Radius of | | | | |
|---|---|---|---|---|---|
| | curvaturer | Relationship | Hc | SNR | Particle |
| | (nm) | between d and r | (kOe) | (dB) | separation |
| Example 1 | 5.5 | 0.5d ≦ r ≦ 1.5d | 3.2 | 15 | ⊚ |
| Comparative | 22 | 1.5d < r | 4.0 | 1 | Δ |
| Example 1 | | | | | |

In example 1, nearly 100% of magnetic grains traced the projections of the underlayer and grew in the form of a column. In comparative example 1, magnetic grains showed clear continuation with adjacent particles at the position where the radius of curvature increases, and only 50% thereof traced the projections of the underlayer. Accordingly, pinning of the domain wall did not work and the signal-to-noise ratio decreased.

As can be understood from the above, if the radius of curvature r of the first underlayer satisfies 0.5d≦r≦1.5d, good particle separation is achieved and accordingly, the signal-to-noise ratio is improved.

### Example 2

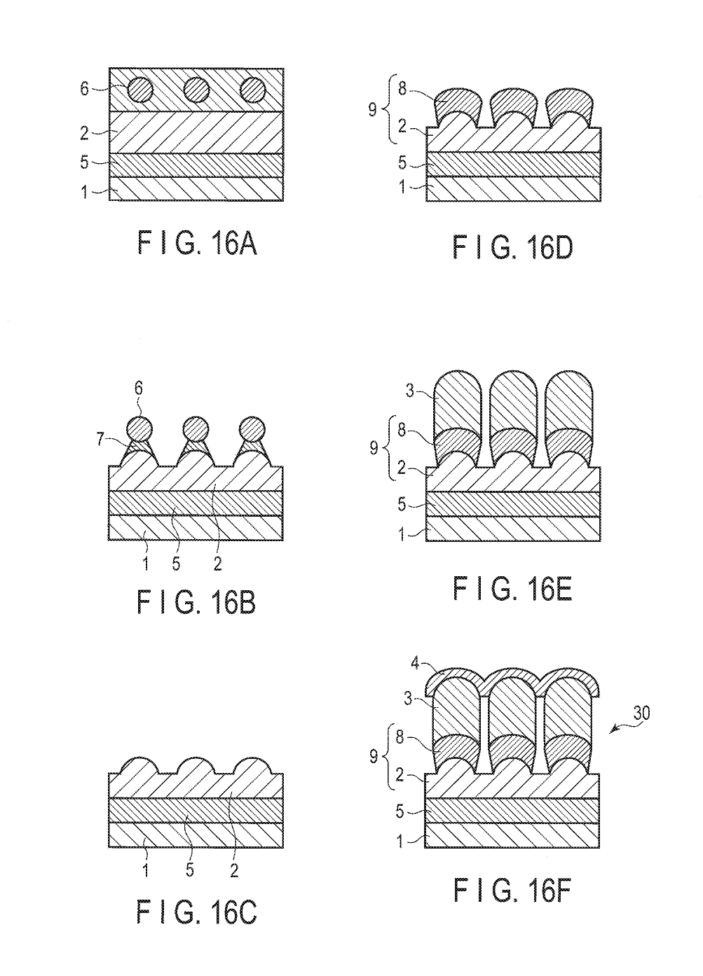

FIGS. 16A to 16F show another example of a manufacturing method of a magnetic recording medium of the present embodiment.

As shown in FIG. 16A, a soft magnetic undercoating layer 5 formed of CoZrNb having a thickness of 50 nm and a first underlayer 2 formed of C having a thickness of 20 nm are formed on a glass substrate 1. Thereupon, FeOₓ nanopartcles 6 having a diameter of 7 nm are applied in a monolayer fashion. Polystyrene of 1000 molecule weight is adhered to the nanopartcles 6 as a protective group and the nanopartcles 6 are arranged on the substrate with an average interval of 10 nm. After the arrangement, the nanopartcles 6 form a hexagonal close-packed pattern as in FIG. 2.

As shown in FIG. 16B, the first underlayer 2 formed of C is subjected to dry etching using the FeOₓ nanopartcles 6 as masks such that the first underlayer 2 and polystyrene around the nanopartcles 6 are etched. Consequently, projections are formed on the surface. This process is performed by, for example, an induction coupling plasma (ICP) RIE apparatus with O₂ used as a process gas, a 0.1 Pa chamber pressure, coil RF power of 50 W and platen RF power of 40 W, and etching time of 30 seconds. Through this process, the C underlayer 2 is etched and the underlayer having projections of a height of 10 nm is formed.

As shown in FIG. 16C, FeOₓ nanopartcles 6 are removed from the first underlayer 2. The substrate 1 is soaked in hydrochloric acid of 1 wt % concentration for 10 minutes such that the FeOₓ nanopartcles 6 are removed from the substrate 1. The substrate 1 is cleansed with pure water to prevent corrosion by a hydrochloric acid residue.

Then, as shown in FIG. 16D, an anti-oxidation layer Ni₄₀Ta₆₀ having a thickness of 5 nm as a second underlayer 8 is deposited on the projections first underlayer 2. Consequently, a double-layered underlayer 9 including the uneven underlayer 2 and the anti-oxidation layer as the second underlayer 8 is prepared.

As shown in FIG. 16E, an amorphous magnetic recording layer 3 is deposited on the anti-oxidation layer 8. Initially, Tb₃₀Co₇₀ with a thickness of 5 nm and Pt with a thickness of 1.5 nm are deposited. Then, Tb₃₀Co₇₀ with a thickness of 5 nm and Pt with a thickness of 1.5 nm are twice further deposited thereon. Consequently, a multilayered magnetic recording layer 3 including Tb₃₀Co₇₀ and Pt and having a total thickness of 19.5 nm is deposited.

Furthermore, as shown in FIG. 16F, a DLC protective layer 4 with a thickness of 4 nm is deposited on the magnetic recording layer 3 through chemical vapor deposition (CVD), and a lubricant (not shown) is applied thereto. Consequently, a target magnetic recording medium 30 is obtained.

The medium 30 obtained as above was evaluated by a Kerr effect measurement device. Consequently, the squareness ratio of 1, Hc=4.0 kOe, Hn=1.8 kOe, and Hs=7.4 kOe were confirmed. Furthermore, a loop gradient α in the proximity of the coercivity Hc was 0.5. From the magnetization curve, the medium 30 is estimated not to be a magnetic wall transfer type but to be a reverse mode in which magnetically isolated magnetic grains are rotated magnetically.

The structure of the medium was evaluated by a vertical section TEM. Within the field of view, the amorphous magnetic recording layer showed a columnar structure. The radius of curvature r at a tip of the second underlayer immediately below the amorphous magnetic recording layer was measured. An average of r was 6.0 nm which satisfied 0.5d≦r≦1.5d where average interval d was 10 nm.

### Example 3

In example 3, magnetic recording media were manufactured in the same manner as example 1 to have projections with an average interval of 10 nm therebetween except that the structures of the magnetic recording layer and an underlayer immediately below the magnetic recording layer were changed as in Table 2 below. Examples 3-1 to 3-3 in which amorphous materials were used and comparative examples 3-1 and 3-2 in which crystalline recording layers were used were prepared.

Magnetic grains of the magnetic recording layer of each medium prepared were subjected to SEM imaging. Areas of particles were measured from the SEM imaging result, the measured areas were approximated by a circle, and variability of diameters (percentage to an average value) of each example was acquired.

Table 2 shows the results. In the table, if variability was 15% or less, ◯ was added. If variability was 25% or less, Δ was added. If variability was 40% or more, X was added.

TABLE 2

| | Underlying layer | | | |
|---|---|---|---|---|
| | immediately | | | |
| | below | r | Recording | |
| | recording layer | (nm) | layer structure | Variability |
| Example 3-1 | None | 5.5 | Tb₂₅Co₇₅ (15 nm) | ◯ |
| Example 3-2 | NiTa | 6.5 | Tb₃₀Co₇₀ (13 nm)/ | ◯ |
| | (2 nm) | | Tb₁₅Co₈₀Cr₅ (2 nm) | |
| Example 3-3 | NiTa | 6.3 | [Tb₂₅Co₇₅ (5 nm)/ | ◯ |
| | (5 nm) | | Pt (1 nm)]₃ | |
| Comparative | Pd | 5.3 | [Co (0.8 nm)/ | X |
| Example 3-1 | (2 nm) | | Pd (0.4 nm)]₈ | |
| Comparative | Ru | 5.1 | Co₈₀Pt₂₀ (15 nm) | X |
| Example 3-2 | (10 nm) | | | |

Examples 3-1 to 3-3 directed to the amorphous magnetic recording layer traced the projections of the underlayer and showed good variability of 15% or less. On the contrary, comparative examples 3-1 and 3-2 directed to the crystalline recording layer showed poor variability such that different crystal grains were produced on the projections and crystal grains grew without successfully tracing the projections of the underlayer.

As can be understood from the above, the magnetic recording medium with small particle size variability is achieved when an amorphous material is used for the magnetic recording layer. Since different materials are used in the above examples and comparative examples, a comprehensive comparison based on a factor such as the signal-to-noise ratio cannot be made; however, the above results show that the amorphous magnetic recording layer with small particle size variability will reduce jitter noise.

### Example 4

In example 4, magnetic recording media were manufactured in the same manner as example 2 except that the height of projections of the first underlayer formed of C and the thickness of the NiTa layer as an anti-oxidation layer were changed as in Table 3. Table 3 also shows the radius of curvature r acquired from vertical section TEM imaging and a relationship between d and r of each example.

TABLE 3

| | | Thick- | | Relation- | | |
|---|---|---|---|---|---|---|
| | Height of | ness | | ship | | Shape |
| | convex | of NiTa | r | between | SNR | of |
| | (nm) | (nm) | (nm) | d and r | (dB) | particles |
| Comparative | 10 | 2 | 4.5 | r = 0.45d | 10 | Fan |
| Example 4-1 | | | | | | |
| Example 4-1 | 7 | 5 | 5.5 | r = 0.55d | 15 | Pillar |
| Example 4-2 | 7 | 10 | 6.0 | r = 0.60d | 16 | Pillar |
| Example 4-3 | 3 | 10 | 9.0 | r = 0.90d | 17 | Pillar |
| Example 4-4 | 3 | 15 | 14.5 | r = 1.45d | 12 | Pillar |
| Comparative | 2 | 10 | 25.0 | r = 2.5d | 1 | Film |
| Example 4-2 | | | | | | |

Media of examples 4-1 to 4-4 and comparative examples 4-1 and 4-2 were evaluated based on the same method as in example 1 with respect to writing/reading characteristics. Comparative example 4-1 showed a relationship r<0.5d and particles therein grew in the form of a fan. In the medium of comparative example 4-1, particle separation was good while the signal-to-noise ratio is slightly lower than that of examples 4-1 to 4-4. This is caused by a space produced in the substrate side of the fan-like particles. Even if the same amount of deposition was carried out, such a space reduces magnetic volume as compared to the columnar particles. The media of examples 4-1 to 4-4 satisfied 0.5d≦r≦1.5d, and all showed a columnar structure by a vertical section TEM evaluation. Furthermore, the signal-to-noise ratio was good. The medium of comparative example 4-2 showed 1.5d<r and the magnetic grains therein did not grow in the form of a column. The signal-to-noise ratio was poor. This is because, as in comparative example 1, pinning of the domain wall did not work and recording could not be retained.

As can be understood from the above, if the radius of curvature r of the underlayer satisfies Relationship 1, excellent read/write characteristics are obtained.

### Example 5

In example 5, magnetic recording media were manufactured in the same manner as example 2 except that the average interval between projections was changed as in Table 4. Media of examples 5-1 to 5-5 and comparative examples 5-1 and 5-2 were manufactured. Note that the radius of curvature r of the outermost surface of the underlayer was set to satisfy 0.5d≦r≦1.5d in each example. Magnetic grains of the magnetic recording layer of each medium were observed by a vertical section TEM measurement, and how they grew (fan, column, or film) was classified.

TABLE 4

| | Average interval | | Relationship | |
|---|---|---|---|---|
| | between convexes | r | between | Shape of |
| | (nm) | (nm) | r and d | particles |
| Comparative | 2.5 | 3.1 | r = 1.2d | Film |
| Example 5-1 | | | | |
| Example 5-1 | 3.5 | 3.8 | r = 1.1d | Pillar |
| Example 5-2 | 6.4 | 4.4 | r = 0.69d | Pillar |
| Example 5-3 | 10.2 | 6.0 | r = 0.59d | Pillar |
| Example 5-4 | 14.4 | 7.8 | r = 0.54d | Pillar |
| Example 5-5 | 17.0 | 8.6 | r = 0.51d | Pillar |
| Comparative | 22.0 | 11.7 | r = 0.53d | Fan |
| Example 5-2 | | | | |

The above results showed that the magnetic recording layer grew in the form of a column if average interval d between projections of the underlayer was set within a range 3 to 20 nm while the radius of curvature r satisfied 0.5≦r≦1.5d. If d was below 3 nm, the absolute value of gaps between projections became small even if 0.5≦r≦1.5d was satisfied, and the magnetic recording layer grew in the form of a film because of a lack of the effect of the underlayer. If d was above 20 nm, the absolute value of gaps between projections became large even if 0.5≦r≦1.5d was satisfied, and the magnetic recording layer grew in the form of a fan because of adhesion of the magnetic recording layer materials to sidewalls of the projections.

As can be understood from the above, if average interval d between projections of the underlayer is within a range of 3 to 20 nm, a columnar structure is obtained.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A perpendicular magnetic recording medium comprising:
a substrate;
an underlayer including a plurality of projections arranged on the substrate at an average interval of 3 to 20 nm; and
an amorphous magnetic recording layer having a plurality of magnetic grains formed as a column on the surface of the projections, the magnetic grains each having a magnetization easy axis in a direction perpendicular to a surface of the underlayer, wherein
the projections are represented by the following formula (1)
0.5≦r≦1.5d (1)
where r is the radius of curvature of a vertical section of each projection and d is the average interval between the projections.

2. The perpendicular magnetic recording medium of claim 1, wherein the underlayer has a multilayered structure of a first underlayer including projections and a second underlayer including projections formed on the first underlayer.

3. The perpendicular magnetic recording medium of claim 2, wherein the second underlayer is amorphous.

4. The perpendicular magnetic recording medium of claim 2, wherein the second underlayer is an anti-oxidation layer.

5. The perpendicular magnetic recording medium of claim 4, wherein the anti-oxidation layer includes at least one element selected from a group consisting of titanium, tantalum, hafnium, niobium, and zirconium, and at least one element selected from a group consisting of chrome, iron, nickel, copper, molybdenum, rhodium, palladium, and iridium.

6. The perpendicular magnetic recording medium of claim 4, wherein the anti-oxidation layer has a thickness of 1 to 30 nm.

7. The perpendicular magnetic recording medium of claim 1, wherein the amorphous magnetic recording layer contains a rare-earth element-transition metal alloy.

8. The perpendicular magnetic recording medium of claim 7, wherein the rare-earth element-transition metal alloy contains any of samarium, gadolinium, terbium, and dysprosium as a rare-earth element.

9. The magnetic recording medium of claim 7, wherein the rare-earth element-transition metal alloy contains one of iron and cobalt as a transition metal.

10. The perpendicular magnetic recording medium of claim 7, wherein the rare-earth element-transition metal alloy contains a terbium-cobalt alloy.

11. The perpendicular magnetic recording medium of claim 1, wherein the amorphous magnetic recording layer contains an additive which is any one of platinum, gold, silver, indium, chrome, titanium, silicon, aluminum, and boron.

12. The perpendicular magnetic recording medium of claim 11, wherein an amount of the additive is 30% or less of an entire composition of the amorphous magnetic recording layer.

13. The perpendicular magnetic recording medium of claim 1, wherein the amorphous recording layer has a thickness of 3 to 30 nm.

14. The perpendicular magnetic recording medium of claim 1, further comprising a nonmagnetic protective layer, wherein the nonmagnetic protective layer protects a part or the entirety of sidewalls of the amorphous magnetic recording layer.

15. The perpendicular magnetic recording medium of claim 14, wherein the nonmagnetic protective layer includes one to five layers therein.

16. The perpendicular magnetic recording medium of claim 14, wherein the nonmagnetic protective layer has a thickness of 0.5 to 3 nm.

17. The perpendicular magnetic recording medium of claim 14, wherein a total thickness of the nonmagnetic protective layer is one third or less of a total thickness of the amorphous magnetic recording layer.

18. The perpendicular magnetic recording medium of claim 14, wherein the nonmagnetic protective layer is formed of any of or an alloy of Pt, Pd, Au, Cu, Cr, and Al.

19. The perpendicular magnetic recording medium of claim 1, wherein, in the proximity of a crossing point representing the coercivity, the gradient α of the magnetization curve of the amorphous magnetic recording layer is less than five, the gradient being given by the following formula (2)
α=4πdM/dH|H=Hc (2)
where M is the magnetization, H is the magnetic field, and Hc is the coercivity.

20. A manufacturing method of a perpendicular magnetic recording medium, the method comprising:
forming, on a substrate, an underlayer including projections; and
depositing an amorphous magnetic recording layer on surfaces of the projection,
wherein the forming the underlayer including projections comprises:
forming a first underlayer on the substrate;
applying a nanoparticle dispersion fluid on the first underlayer to form a nanoparticle monolayer; and
etching the first underlayer through the nanopartcles, and
wherein the projections included in the underlayer are represented by the following formula (1)
0.5d≦r≦1.5d (1)
where r is the radius of curvature of a vertical section of each projection and d is the average interval between the projections.

21. The manufacturing method of claim 20, further comprising:
forming a second underlayer including projections in advance to the deposition of the amorphous magnetic recording layer; and
forming a multilayered underlayer including the first underlayer and the second underlayer, wherein
the projections included in the multilayered underlayer are represented by the following formula (1)
0.5d≦r≦1.5d (1)
where r is the radius of curvature of a vertical section of each projection and d is the average interval between the projections.

22. The manufacturing method of claim 21, wherein the second underlayer is amorphous.

23. The manufacturing method of claim 21, wherein the second underlayer is an anti-oxidation layer.

24. The manufacturing method of claim 23, wherein the anti-oxidation layer includes at least one element selected from a group consisting of titanium, tantalum, hafnium, niobium, and zirconium, and at least one element selected from a group consisting of chrome, iron, nickel, copper, molybdenum, rhodium, palladium, and iridium.

25. The manufacturing method of claim 23, wherein the anti-oxidation layer has a thickness of 1 to 30 nm.

26. The manufacturing method of claim 20, wherein the amorphous magnetic recording layer contains a rare-earth element-transition metal alloy.

27. The manufacturing method of claim 26, wherein the rare-earth element-transition metal alloy contains any of samarium, gadolinium, terbium, and dysprosium as a rare-earth element.

28. The manufacturing method of claim 26, wherein the rare-earth element-transition metal alloy contains one of iron and cobalt as a transition metal.

29. The manufacturing method of claim 26, wherein the rare-earth element-transition metal alloy contains a terbium-cobalt alloy.

30. The manufacturing method of claim 20, wherein the amorphous magnetic recording layer contains an additive which is any one of platinum, gold, silver, indium, chrome, titanium, silicon, aluminum, and boron.

31. The manufacturing method of claim 30, wherein an amount of the additive is 30% or less of an entire composition of the amorphous magnetic recording layer.

32. The manufacturing method of claim 20, wherein the amorphous recording layer has a thickness of 3 to 30 nm.

33. The manufacturing method of claim 20, wherein the depositing an amorphous magnetic recording layer includes a single formation of a multilayer of the amorphous magnetic recording layer and the nonmagnetic protective layer or two or more repetitions of the formation of the multilayer, and
the nonmagnetic protective layer protects a part or the entirety of sidewalls of the amorphous magnetic recording layer.

34. The manufacturing method of claim 33, wherein the nonmagnetic protective layer includes one to five layers therein.

35. The manufacturing method of claim 33, wherein the nonmagnetic protective layer has a thickness of 0.5 to 3 nm.

36. The manufacturing method of claim 33, wherein a total thickness of the nonmagnetic protective layer is one third or less of a total thickness of the amorphous magnetic recording layer.

37. The manufacturing method of claim 33, wherein the nonmagnetic protective layer is formed of any of or an alloy of Pt, Pd, Au, Cu, Cr, and Al.

38. The manufacturing method of claim 20, wherein, in the proximity of a crossing point representing the coercivity, the gradient α of the magnetization curve of the amorphous magnetic recording layer is less than five, the gradient given by the following formula (2)
α=4πdM/dH|H=Hc (2)
where M is the magnetization, H is the magnetic field, and Hc is the coercivity.

39. A manufacturing method of a perpendicular magnetic recording medium, the method comprising:
forming, on a substrate, an underlayer including projections; and
depositing an amorphous magnetic recording layer on the surfaces of the projections,
wherein the forming comprises:
forming an underlayer including projections a first underlayer on the substrate, the first underlayer formed of a metal compound having a eutectic structure of particles and grain boundaries; and
etching the first underlayer to keep the particles of the eutectic structure, and
wherein the projections included in the underlayer are represented by the following formula (1)
0.5≦r≦1.5d (1)
where r is the radius of curvature of a vertical section of each projection and d is the average interval between the projections.

40. The manufacturing method of claim 39, further comprising:
forming in advance of the deposition of the amorphous magnetic recording layer a second underlayer including projections; and
forming a multilayered underlayer including the first underlayer and the second underlayer, wherein
the projections included in the multilayered underlayer are represented by the following formula (1)
0.5d≦r≦1.5d (1)
where r is the radius of curvature of a vertical section of each projection and d is the average interval between the projections.

41. The manufacturing method of claim 40, wherein the second underlayer is amorphous.

42. The manufacturing method of claim 40, wherein the second underlayer is an anti-oxidation layer.

43. The manufacturing method of claim 42, wherein the anti-oxidation layer includes at least one element selected from a group consisting of titanium, tantalum, hafnium, niobium, and zirconium, and at least one element selected from a group consisting of chrome, iron, nickel, copper, molybdenum, rhodium, palladium, and iridium.

44. The manufacturing method of claim 42, wherein the anti-oxidation layer has a thickness of 1 to 30 nm.

45. The manufacturing method of claim 39, wherein the amorphous magnetic recording layer contains a rare-earth element-transition metal alloy.

46. The manufacturing method of claim 45, wherein the rare-earth element-transition metal alloy contains any of samarium, gadolinium, terbium, and dysprosium as a rare-earth element.

47. The manufacturing method of claim 45, wherein the rare-earth element-transition metal alloy contains one of iron and cobalt as a transition metal.

48. The manufacturing method of claim 45, wherein the rare-earth element-transition metal alloy contains a terbium-cobalt alloy.

49. The manufacturing method of claim 39, wherein the amorphous magnetic recording layer contains an additive which is any one of platinum, gold, silver, indium, chrome, titanium, silicon, aluminum, and boron.

50. The manufacturing method of claim 49, wherein an amount of the additive is 30% or less of an entire composition of the amorphous magnetic recording layer.

51. The manufacturing method of claim 39, wherein the amorphous recording layer has a thickness of 3 to 30 nm.

52. The manufacturing method of claim 39, wherein the depositing an amorphous magnetic recording layer includes a single formation of a multilayer of the amorphous magnetic recording layer and the nonmagnetic protective layer or two or more repetitions of the formation of the multilayer, and
the nonmagnetic protective layer protects a part or the entirety of sidewalls of the amorphous magnetic recording layer.

53. The manufacturing method of claim 52, wherein the nonmagnetic protective layer includes one to five layers therein.

54. The manufacturing method of claim 52, wherein the nonmagnetic protective layer has a thickness of 0.5 to 3 nm.

55. The manufacturing method of claim 52, wherein a total thickness of the nonmagnetic protective layer is one third or less of a total thickness of the amorphous magnetic recording layer.

56. The manufacturing method of claim 52, wherein the nonmagnetic protective layer is formed of any of or an alloy of Pt, Pd, Au, Cu, Cr, and Al.

57. The manufacturing method of claim 39, wherein, in the proximity of a crossing point representing the coercivity, the gradient α of the magnetization curve of the amorphous magnetic recording layer is less than five, the gradient given by the following formula (2)
α=4πdM/dH|H=Hc (2)
where M is the magnetization, H is the magnetic field, and Hc is the coercivity.
